(19) United States
(12) Patent Application Publication
(10) Pub. No.: US 2024/0286830 A1
(43) Pub. Date: Aug. 29, 2024

(54) CABLE ASCENDED CONTAINER UNLOADER

(71) Applicant: Jared D. Horton, Glenwood, IA (US)

(72) Inventor: Jared D. Horton, Glenwood, IA (US)

(21) Appl. No.: 18/590,440

(22) Filed: Feb. 28, 2024

Related U.S. Application Data
(60) Provisional application No. 63/448,921, filed on Feb. 28, 2023.

(51) Int. Cl. B65F 1/14; B65G 65/23

(52) U.S. Cl. CPC B65F 1/1452; B65G 65/23

(57) ABSTRACT

The present disclosure is a cable ascended container unloader for construction, including a lift cable. In an embodiment of the disclosure, cable ascended container unloader may include a frame including an attachment point configured to attach to a lift cable, a second frame to rotate downward with and a means of quick attachment to a trashcan, and a releasing drop lever for use to unload the trashcan. The cable ascended container unloader may further have an attachment point ready to attach to a lift cable or lift chain.

### CROSS REFERENCE TO RELATED APPLICATIONS

The present application claims the benefit under 35 U.S.C. § 119(e) of U.S. Provisional Application Ser. No. 63/448,921 filed Feb. 28, 2023. The U.S. Provisional Application Ser. No. 63/448,921 filed Feb. 28, 2023 is hereby incorporated by reference in its entirety.

### TECHNICAL FIELD

The present disclosure generally relates to the field of construction; and more specifically to a cable ascended container unloader for demolition, general construction, material handling and object handling.

### BACKGROUND

Moving material from one place to another or moving material that is not desirable out of a given area may have been fundamental actions to improving what humans can do, have, or enjoy. Manual labor allows humans to move items in a piece-by-piece manner, or load by load. Conventional tools have been developed and used to improve operations required by humans.

When materials need to be moved from one location to another location at similar elevations, a simple device such as a cart with wheels may suffice. If materials need to be raised from one elevation to another, a lifting device such as a crane or a forklift may be utilized, but only if the material can be contained, then raised or lowered. A device which would allow the movement of material from a first location at a first elevation to a second location at a second elevation would be desirable.

### SUMMARY

Accordingly, the present disclosure is directed to a cable ascended container unloader. In an embodiment of the disclosure, the cable ascended container unloader may include a frame that attaches to a cable, the frame including a quick attachment device configured to secure a container.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 depicts a side view of a cable ascended container unloader in accordance with an embodiment of the present disclosure;

FIG. 2 depicts a cable ascended container unloader with the container near, but not connected to the cable ascended container unloader in accordance with an embodiment of the present disclosure;

FIG. 3 depicts a plan view of a cable ascended container unloader with a single container attached and in the upright position with a section line to be referenced in following drawing cross-sections in accordance with an embodiment of the present disclosure;

FIG. 4 depicts a cross section of a cable ascended container unloader with the container attached to a container adapter, near to placement against the rotating attachment frame, but not touching or secured to the cable ascended container unloader in accordance with an embodiment of the present disclosure;

FIG. 5 depicts a side view of a cable ascended container unloader with the container attached to a container adapter, near to placement against the rotating attachment frame with the adapter retention lever down, but not touching or secured to a cable ascended container unloader in accordance with an embodiment of the present disclosure;

FIG. 6 depicts a side view of a cable ascended container unloader with the container attached to a container adapter, near to placement against the rotating attachment frame with the container retention lever up, but not touching or secured to a cable ascended container unloader in accordance with an embodiment of the present disclosure;

FIG. 7 depicts a side view of a cable ascended container unloader with the container adapter fully set at the base, the container retention lever up, with the rotating attachment frame in the upright position in accordance with an embodiment of the present disclosure;

FIG. 8 depicts a side view of a cable ascended container unloader with the container adapter fully set with the container retention lever down, but the rotating attachment frame has been released from the upright position in accordance with an embodiment of the present disclosure;

FIG. 9 depicts a side view cross section of a cable ascended container unloader with the container fully secured to the device and with the rotating attachment frame in a position 135 degrees folded out from the mast and the fold cable in position to raise the rotating attachment frame back into the upright position in accordance with an embodiment of the present disclosure;

FIG. 10 depicts a front view of a cable ascended container unloader without the container, but with one container adapter in accordance with an embodiment of the present disclosure;

FIG. 11 depicts a back view of a cable ascended container unloader in accordance with an embodiment of the present disclosure; and

12A-12B depict exemplary dimensions of a cable ascended container unloader 100 in accordance with an embodiment of the present disclosure.

### DETAILED DESCRIPTION

Reference will now be made in detail to the subject matter disclosed, which is illustrated in the accompanying drawings.

Before any embodiments of the disclosure are explained in detail, it is to be understood that the embodiments may not be limited in application per the details of the structure or the function as set forth in the following descriptions or illustrated in the figures. Different embodiments may be capable of being practiced or carried out in various ways. Also, it is to be understood that the phraseology and terminology used herein is for the purpose of description and should not be regarded as limiting. The use of terms such as “including,” “comprising,” or “having” and variations thereof herein are generally meant to encompass the item listed thereafter and equivalents thereof as well as additional items. Further, unless otherwise noted, technical terms may be used according to conventional usage. It is further contemplated that like reference numbers may describe similar components and the equivalents thereof.

The present disclosure is directed to a cable ascended container unloader. In an embodiment of the disclosure, the cable ascended container unloader may include a frame that attaches to a cable, the frame including a quick attachment device configured to secure a container. The cable ascended container unloader may be very useful in achieving a task such as moving loose material from a space with limited access that needs to be moved to a space such as an elevator shaft and up to a higher elevation without the use of motorized equipment within that space.

A container may be employed to store trash, rubble, snow, dirt, cement, rock and the like. It is also contemplated that the container may be a garbage can with wheels, such as a such as “Garbage Man Ready Trash Can”. However, other types of containers may be used, such as wheeled carts, wheelbarrows, forks, lumber racks, sheet good racks, grapple hooks, water containers, spears such as a bale spear and the like.

The cable ascended container unloader may include a frame which may attach to a cable that may be connected to a lifting device such as a crane having a boom end above. It is further contemplated that the cable ascended container unloader may be able to have the ability to unload the container by flipping it while securely holding said container until it is safely disconnected for re-filling.

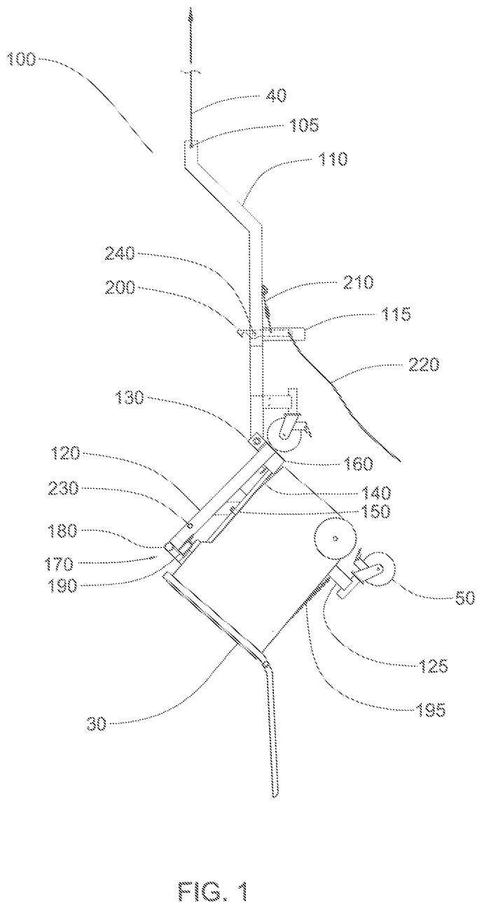

Referring to FIGS. 1 & 9, a side view of a cable ascended container unloader 100 in accordance with an embodiment of the present disclosure is shown in a position as if material had been unloaded while retaining the container. Cable ascended container unloader may include a first frame, the first frame generally being upright while in use like a mast. The frame 110 may include an attachment point 105. Attachment point 105 may be configured to attach to a cable 40. It is contemplated that attachment device 105 may be a device of various means of connection for connecting to cable 40 or a chain. The cable may be formed of any type of material including metal, and it is contemplated that a cable could include a rope.

It is contemplated that the attachment point 105 may be a bolt, hole, ring, D ring, hook, clevis, clasp, shive, pully or one of many other mechanism for attachment. The frame 110 may have a connection mechanism to a second frame 120 that may have the ability to rotate in a downward direction with respect to the first frame 110. It is contemplated this second frame 120 may also have a mechanism for attachment to secure a container. The second frame 120 may be connected to first frame 110 with a hinge 130. It is contemplated hinge 130 may be placed to allow frame 120 to rotate around first frame 110 with the force of gravity once a drop lever 200 is rotated up 25 degrees. It is also contemplated that drop lever 200 may have a mechanism to connect to drop cable 220, wherein an operator not directly within arm's reach of cable ascended container unloader 100 may access the drop cable 220.

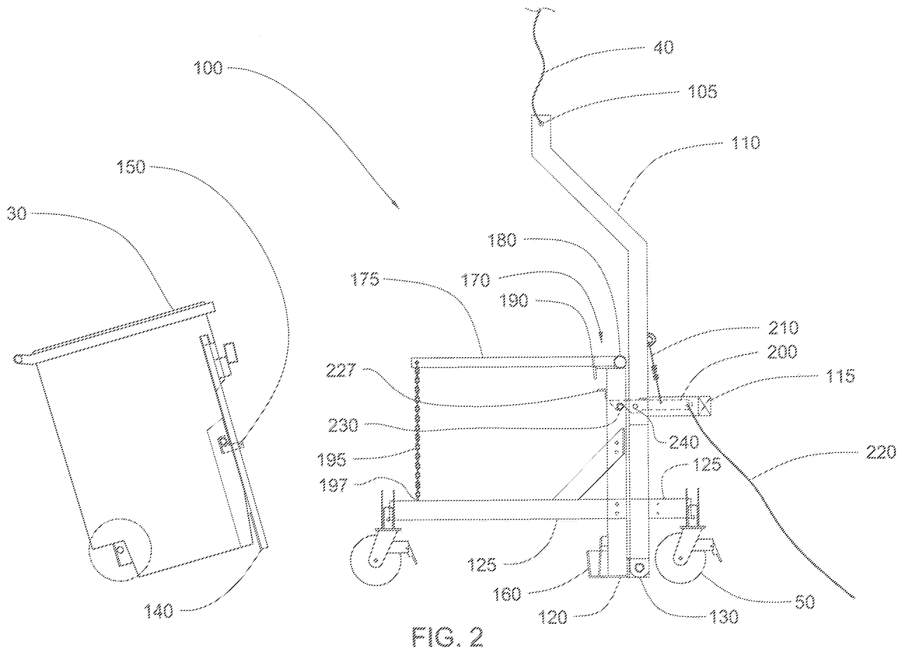

Referring to FIGS. 2-7, side views and a plan view of a cable ascended container unloader 100 in accordance with an embodiment of the present disclosure is shown with the container not attached to the rotating attachment frame 120. It is contemplated that container 30 may be a garbage-man-ready-trashcan. It is also contemplated that container 30 may require container adapter 140 for container 30 to be attached to rotating attachment frame 120. It is also contemplated that container adapter 140 may require container adapter retention device 150 to connect to container 30. Rotating attachment frame 120 may have one or multiple connection points for container 30 to be quickly attached through container adapter 140. It is contemplated that container adapter 140 may freely drop freely into pan 160, which may secure the bottom of container adapter 140. It is also contemplated that container retention device 170 may hold the container 30 in place at the top. Container retention device 170 may include a container retention lever 175, container retention hinges 180, container retention clamp 190, container retention latch 195, container latch coupler 197 and clamp shelf 227. It is contemplated that container retention lever 175 may to be rotated around container retention hinges 180 to clamp down the top of container adapter 140 with container retention clamp 190 on the top. It is contemplated that container retention lever 175 may be retained in place by container retention latch 195. Container retention latch 195 may be a chain coupled to caster bar 125 at container latch coupler 197. It is further contemplated that container retention device 170 may advantageously clamp down with clamp shelf 227.

Cable ascended container unloader 100 may be configured to easily be placed without the operator being able to see the connecting component pan 160 when needed. Pan 160 may be larger in width than the bottom of container adapter 140 and container adapter 140 may have a tapered base that advantageously self aligns container adapter 140 once container 30 is dropped from above into pan 160.

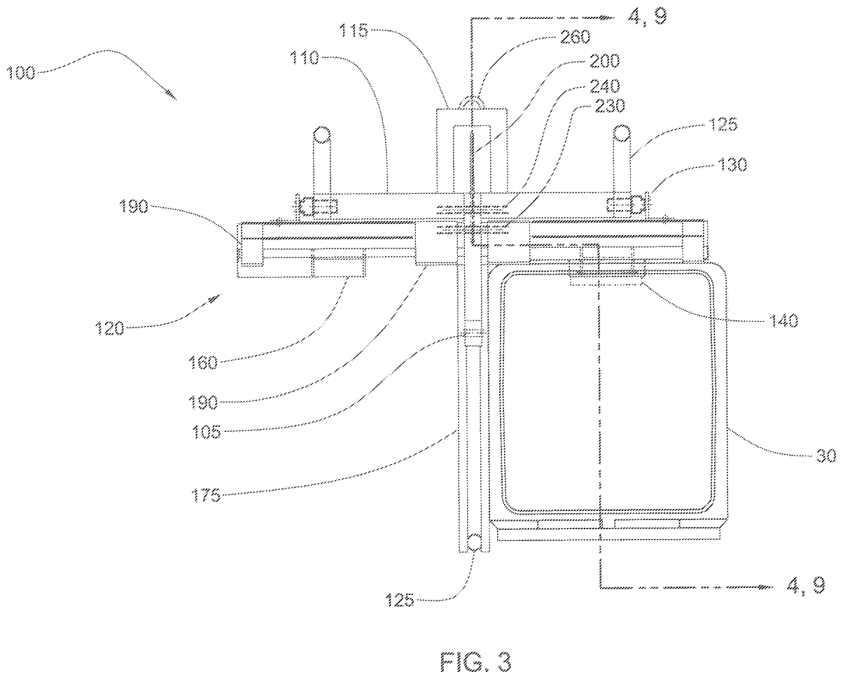

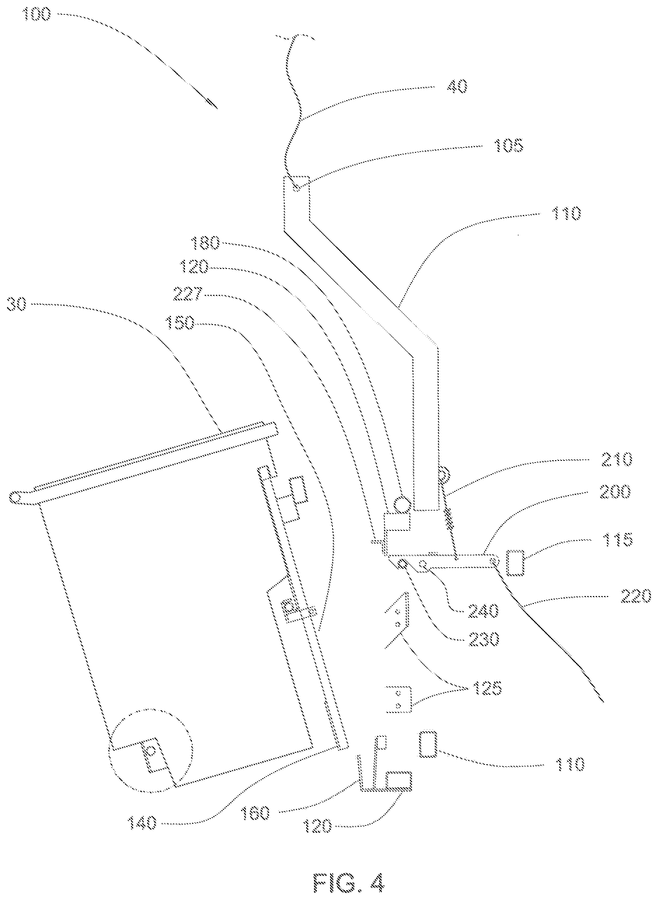

Referring to FIG. 3, container 30 is shown in only one of two bays on cable ascended container unloader 100 on the right side. It is contemplated that one or more containers 30 may be attached to cable ascended container unloader 100. On the left side of cable ascended container unloader 100, pan 160 is shown that may be a recessed portion for container adapter 140 to drop into. It is further contemplated that pan 160 may also be a base plate like that on a furniture dolly, a hook like that on a farm jack or may connect directly to container 30. It is further contemplated that container retention device 170 may also make use of other means to couple to container adapter 140 or container 30. Section line 4,9, may be used in FIGS. 4 & 9 to further understand the parts herein.

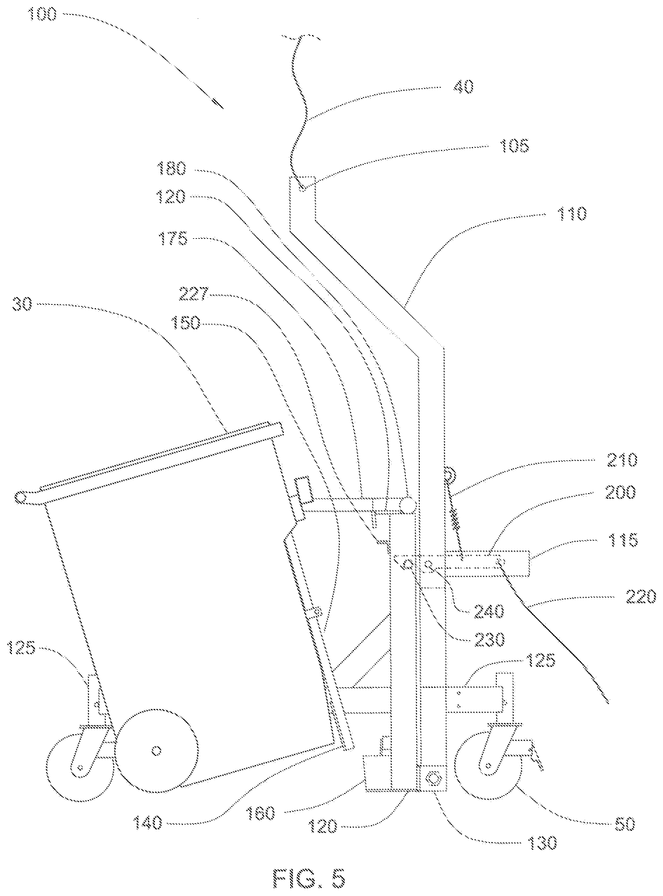

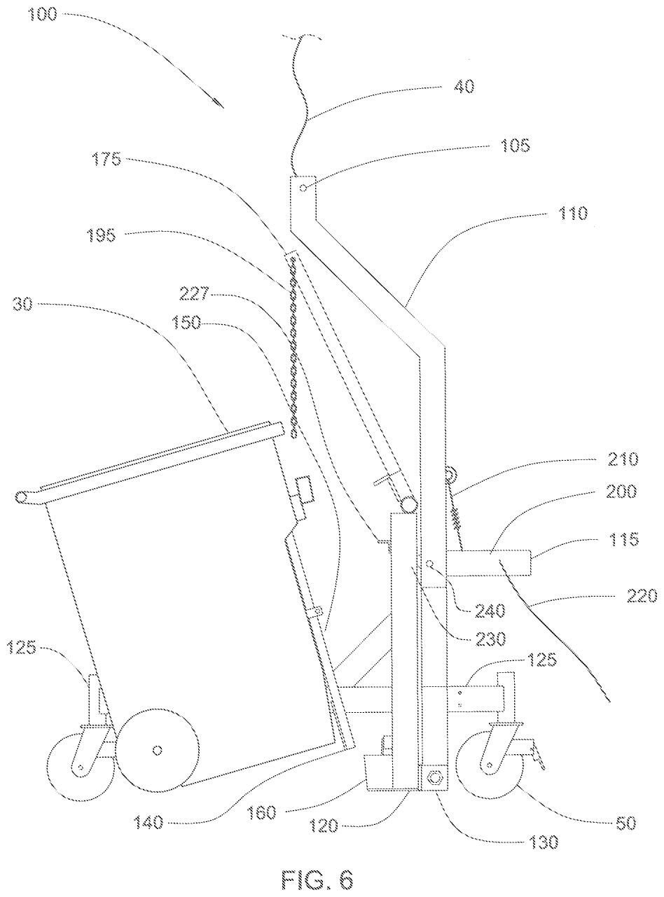

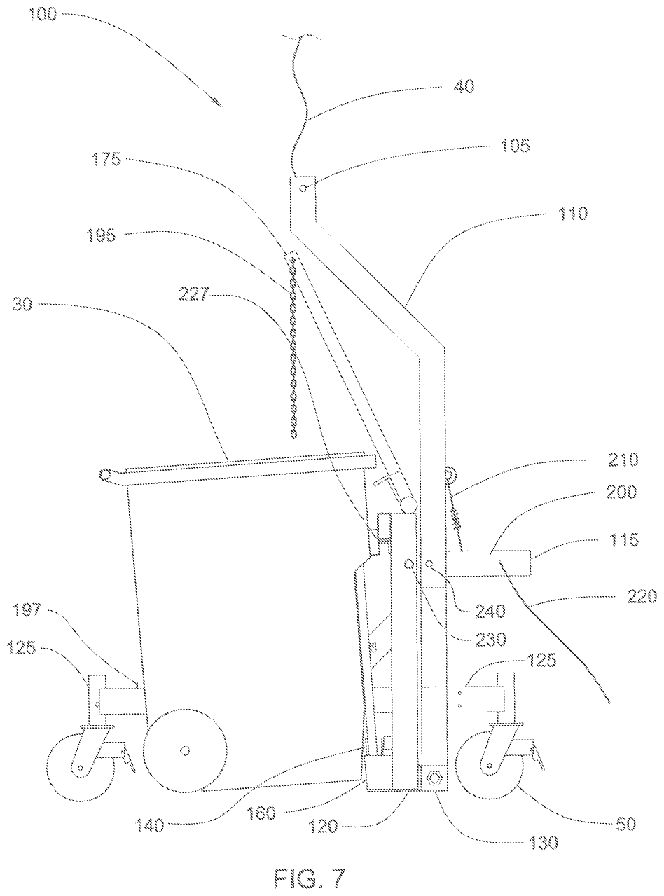

Referring to FIGS. 5-7, cable 40 is shown as a spline which may indicate it is not tight and cable ascended container unloader 100 is on the ground or a surface with casters 50 all making contact with a surface. As shown on FIG. 5, container 30 may be moved from a position away from cable ascended container unloader 100 to a position within inches of cable ascended container unloader 100 without tipping in back container 30, or raising container retention lever 175 or container retention clamps 190. Once container 30 is near to cable ascended container unloader 100 as shown on FIGS. 6-7, container retention device 170 may be opened by raising container retention lever 175 after releasing container latch coupler 197, thereby raising container retention clamp 190 allowing container to be moved into position by placing container adapter 140 into pan 160 and setting the upper portion of container adapter 140 above clamp shelf 227.

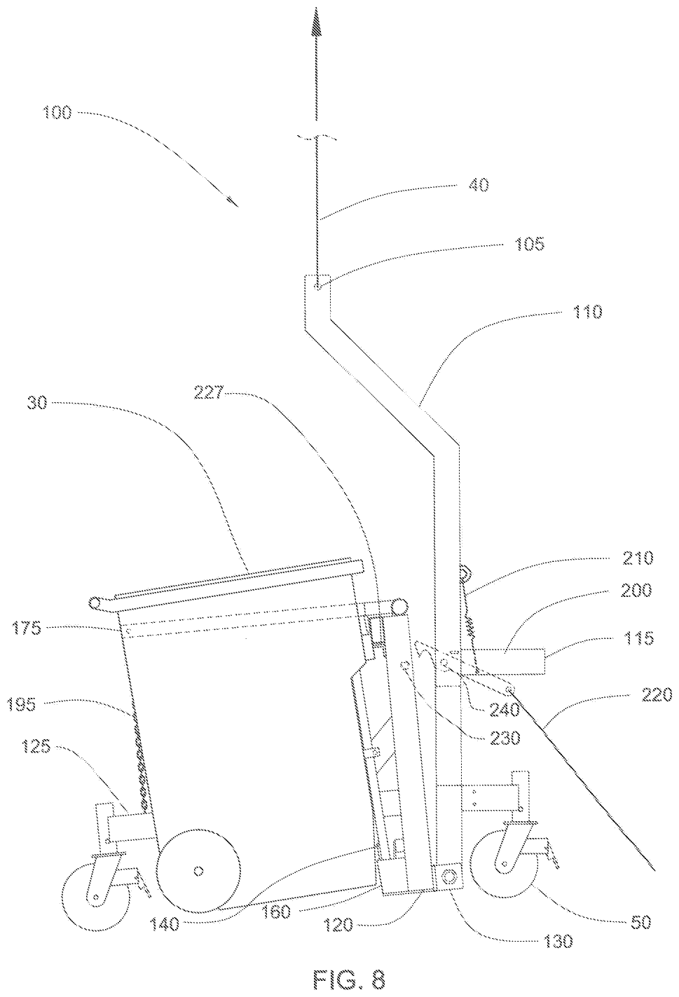

Referring to FIGS. 1, 8 & 9 container retention device 170 has been clamped down which may securely hold container 30 affixed to rotating attachment frame 120. Lift cable 40 is also shown as a strait line to indicate that cable ascended container unloader 100 is now suspended in the air as shown in FIGS. 1, 8 & 9. As shown in FIG. 8, it is contemplated that if drop lever 200 was pulled with drop cable 220 it would rotate around drop hinge 240 and drop lever 200 would disconnect from drop retention pin 230. It is contemplated that rotating attachment frame 120 would then rotate forward and down along with container 30 around unloading hinge 130. These action may advantageously dump the contents of container 30 with little applied force other than gravity.

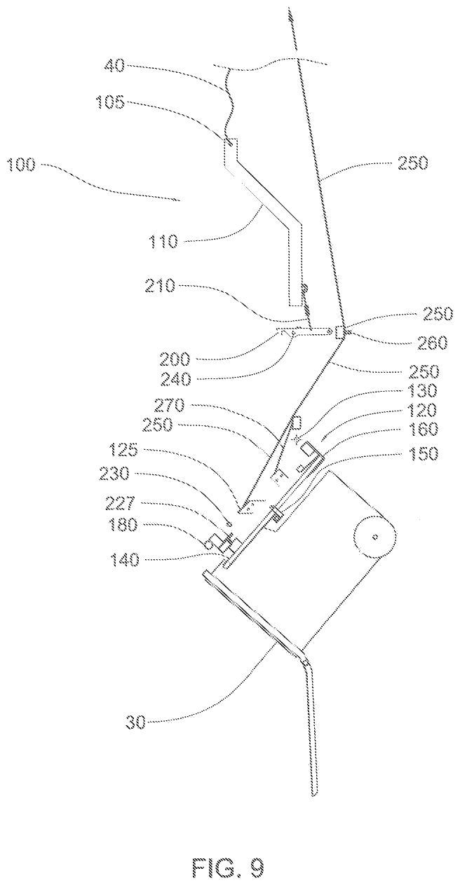

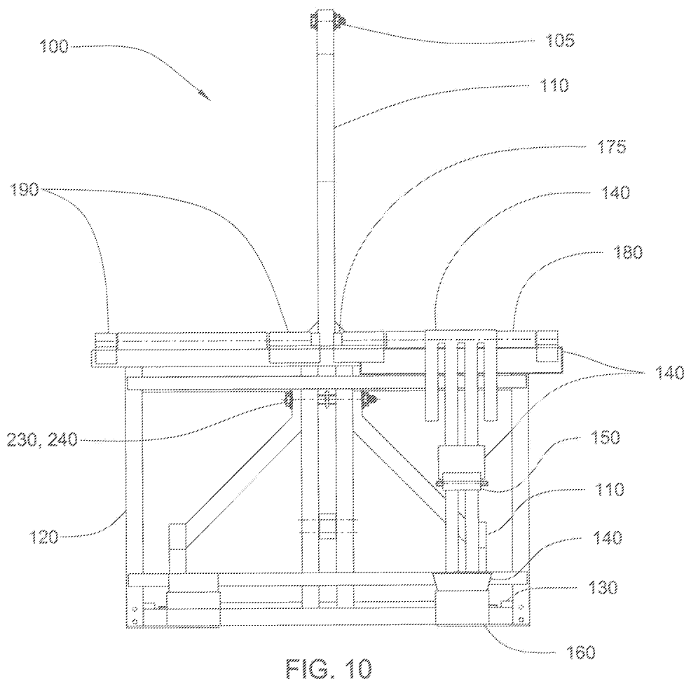

FIG. 9, depicts a side view of a cable ascended container unloader 100 with the container fully secured to the device and with rotating attachment frame 120 in a position held up by fold cable 250 and drop lever 200 rotated 0 degrees held by drop lever spring 210. It is contemplated that drop lever 200 may automatically open when rotating attachment frame 120 is pulled up by fold cable 250. Cable 40 being represented as a spline may indicate that fold cable 250 may have applied tension. By pulling fold cable 250 or may be tightened by partially releasing cable 40. Cable 250 may slide though fold cable guide 260 to keep it in an advantageous alignment. It is contemplated that fold cable 250 may need other fold cable guides for further alignment. It is further contemplated that if fold cable 260 is not kept in an ideal parameter of tension while the container is dropping forward with gravity that rotation control device 270 may be necessary. Rotation control device 270 may be a cable, a catch, a pneumatic cylinder or one of many means of regulation to limit the speed and/or rotation of the container. It is contemplated that fold cable 250 may be used to pull rotating attachment frame 120 up to a point that drop retention pin 230 comes in contact with drop lever 200 and that drop lever 200 will rotate up and then back down once drop retention pin 230 is inside of the hook of drop lever 200 with the assistance of the force of drop lever spring 210.

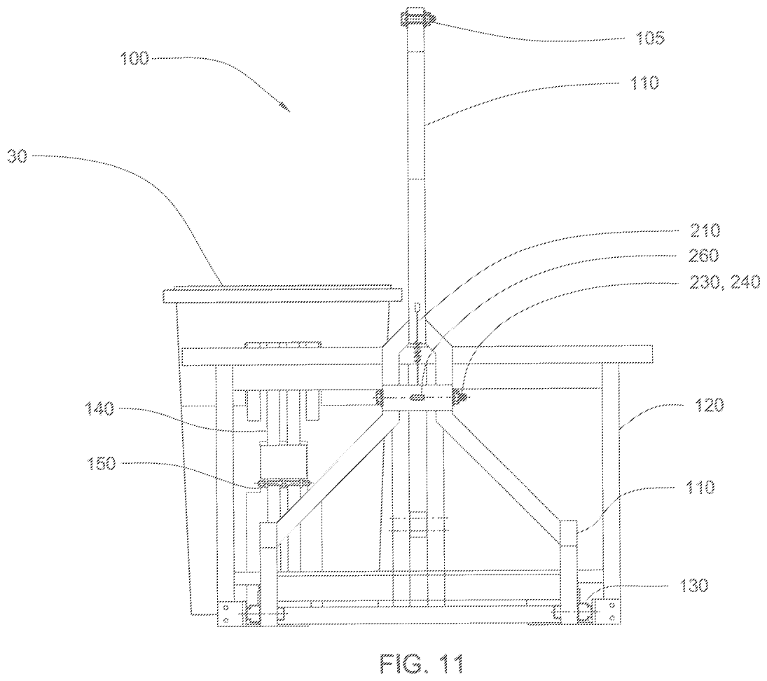

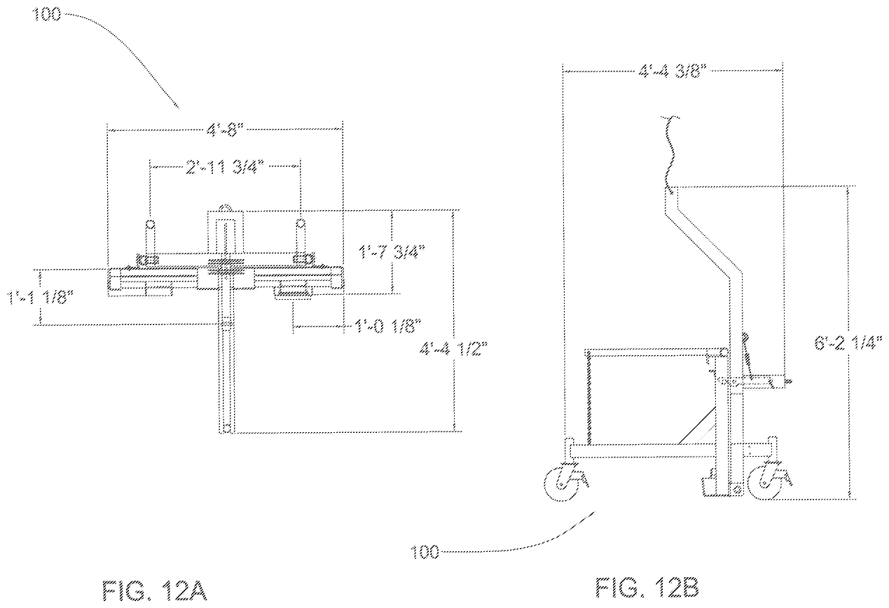

Referring to FIGS. 10 & 11, front and back views of a cable ascended container unloader 100 in accordance with an embodiment of the present disclosure is shown. As in FIG. 3, the left bay of a cable ascended container unloader 100 has the left bay empty for clarity. As shown on FIG. 10, container adapter 140 is in place on one side without container 30. As shown on FIG. 11, container 30 is shown with container adapter 140.

FIGS. 12A & 12B, depict exemplary dimensions of a cable ascended container unloader 100 in accordance with an embodiment of the present disclosure.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

It is contemplated that apparatus, CABLE ASCENDED CONTAINER UNLOADER may be useful in achieving a task such as moving loose material from a space with limited access that needs to be moved to a space such as an elevator shaft and up to a higher elevation without the use of motorized equipment within that space. It is contemplated that the cable ascended container unloader is a device that can accept attachment to a container such as a “Garbage Man Ready Trash Can” and may be attached to a cable or cable that may be connected to a lifting device such as a crane having it's boom end directly above. It is further contemplated that the cable ascended container unloader may be able to have the ability to unload the container by flipping it while securely holding said container until it is safely disconnected for refilling.

Containers may contain material. Advantageously, material may be retrieved, stored, transported and deposited in another location. Material retrieved within a container may include trash, rubble, snow, dirt, cement, rock and the like. It is also contemplated that other types of container like devices may be used. These containers may include wheeled carts, wheelbarrows, forks, lumber racks, sheet good racks, grapple hooks, water containers, spears such as a bale spear and the like

What is claimed is:

1. A cable ascended container unloader, comprising:
a frame, the frame including a connection point for an overhead cable;
a second frame;
the second frame connected to rotate into a downward position for dumping; and
the second frame including an attachment device, the attachment device configured to attach to a garbageman ready trashcan, the trashcan having a side mount for attachment;
and
a drop lever connected to the first frame, the drop lever including at least one catch to release part of the first frame from the second frame, wherein the second frame will rotate downward around the second frame.

2. The cable ascended container unloader as claimed in claim 1, wherein the first frame is generally in an upright position.

3. The cable ascended container unloader as claimed in claim 1, wherein the second frame is generally parallel to the side of the garbageman ready trashcan.

4. A cable ascended container unloader, comprising:
a frame, the frame including a connection point for an overhead cable;
a second frame;
the second frame connected to rotate into a downward position for dumping;
and
the second frame including an attachment device, the attachment device configured to attach to a container, the container having a side mount for attachment;
and
a drop lever connected to the first frame, the drop lever including at least one catch to release part of the first frame from the second frame, wherein the second frame will rotate downward around the second frame.

5. The cable ascended container unloader as claimed in claim 4, wherein the first frame is generally in an upright position.

6. The cable ascended container unloader as claimed in claim 4, wherein the second frame is generally parallel to the side of the container.
